(19) United States
(12) Patent Application Publication
(10) Pub. No.: US 2004/0058722 A1
(43) Pub. Date: Mar. 25, 2004

(54) Directional signal device

(76) Inventors: Hsin-Hao Yang, Taipei City (TW); Yin-Jyh Kuo, Bade City (TW)

Correspondence Address: BIRCH STEWART KOLASCH & BIRCH, PO BOX 747, FALLS CHURCH, VA, 22040-0747, US

(21) Appl. No.: 10/630,725

(22) Filed: Jul. 31, 2003

(30) Foreign Application Priority Data
Sep. 25, 2002 (TW) 091215180

(51) Int. Cl. H04M 1/00

(52) U.S. Cl. 455/575.6

(57) ABSTRACT

A directional signal device includes a battery-operated signal transmitter installed in a vehicle, the signal transmitter having a control circuit board adapted to transmit a directional signal wirelessly and formed of a power circuit, a direction selection circuit an encoder circuit, and a transmitting circuit, and a battery-operated signal receiver carried on the user, the signal receiver having a control circuit board formed of a power circuit, a receiving circuit, a decoder circuit, a comparator circuit, a light driving circuit, and a directional light emitting unit. The signal transmitter is operated by the user to wirelessly transmit a directional signal to the signal receiver, causing the directional light emitting unit of the signal receiver to flash, indicating a direction to follow.

### BACKGROUND OF THE INVENTION

1. Field of the Invention

The present invention relates to a directional signal device and, more particularly, to a directional signal device that is practical for use as a third directional lamp in a vehicle.

2. Description of the Related Art

For the sake of safety, four-wheel motor vehicles are required to have a third rear brake light. However, this requirement is not mandated for motorcycles and bicycles. Although there are safety helmets, riding a bicycle or motorcycle in the dark can be dangerous especially when the rider changes the steering direction suddenly. When turning the bicycle or motorcycle to the left or right, the motorcyclists will switch on the respective directional signal light and the cyclists can only make a hand gesture to show the direction they are about to take. However, due to the poor eyesight in the dark another rider of a trailing motorcycle or bicycle or the driver of the car behind may not be able to see such a directional signal light, and a collision may occur if the rider of a trailing vehicle fails to detect the impending change in speed or direction of the leading cyclist and, consequently, fails to slow down.

### SUMMARY OF THE INVENTION

The present invention has been designed with the above-mentioned circumstances in view. It is the main objective of the present invention to provide a directional signal device, which is practical for use as a third directional lamp in a vehicle. It is another objective of the present invention to provide a directional signal device, which uses wireless signal-transmission technology to transmit directional control signals from a signal transmitter to a signal receiver, causing the signal receiver to display a corresponding flashing warning signal. It is still another objective of the present invention to provide a directional signal device which produces a warning sound in conjunction with the flashing warning signal. It is still another objective of the present invention to provide a directional signal device which allows the signal receiver to be installed on most any article worn or carried by the user, or directly fastened to any part of the user's body.

To achieve these and other objectives of the present invention, the directional signal device comprises a signal transmitter installed in a vehicle, the signal transmitter comprising a power supply, a control circuit board adapted to wirelessly transmit a directional signal, and a casing adapted to accommodate the power supply and control circuit board of the signal transmitter, the control circuit board of the signal transmitter comprising a power circuit, a direction section circuit, an encoder circuit, and a transmitting circuit, and at least one signal receiver carried on the user and adapted to receive directional signal from the signal transmitter, said signal receiver comprising a power supply, a control circuit board, and a casing adapted to accommodate the power supply and control circuit board of the respective signal receiver, the control circuit board of the signal receiver comprising X a power circuit, a receiving circuit, a decoder circuit, a comparator circuit, a light driving circuit, and a directional light emitting unit, wherein the signal transmitter is operated by the user to transmit a directional signal to the signal receiver wirelessly; the signal receiver drives the respective directional light emitting unit to flash, indicating a direction to follow.

### BRIEF DESCRIPTION OF THE DRAWINGS

FIG. 1 illustrates one embodiment of the present invention.

FIG. 2 is an exploded view of another embodiment of the present invention.

FIG. 3 is similar to FIG. 2, but shows the signal transmitter and the signal receivers respectively installed in the bicycle and the user's hands.

FIG. 4 illustrates still another embodiment of the present invention where the signal receivers are respectively installed in the user's gloves.

FIG. 5 is an exploded view of a signal transmitter for the directional signal device according to the present invention.

FIG. 6 is an elevational view of a signal receiver for the directional signal device according to the present invention.

FIG. 7 is a, circuit block diagram of the present invention.

FIG. 8 is an exploded view of the signal receiver for the directional signal device according to the present invention.

FIG. 9 is an elevational view of a LED matrix type directional light emitting unit for the signal receiver according to the present invention.

### DETAILED DESCRIPTION OF THE PREFERRED EMBODIMENT

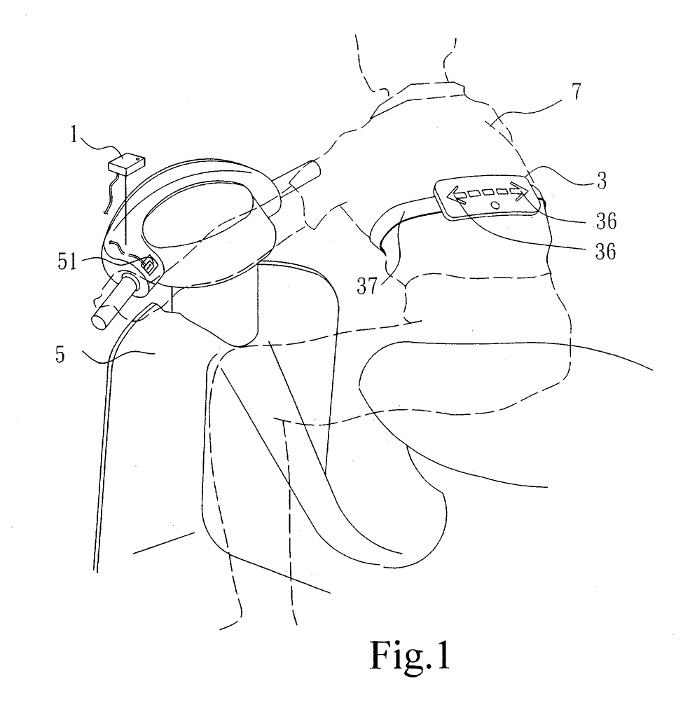

Referring to FIGS. 1-9, a directional signal device in accordance with the present invention is, shown comprised of a signal transmitter 1 and at least one signal receiver 3.

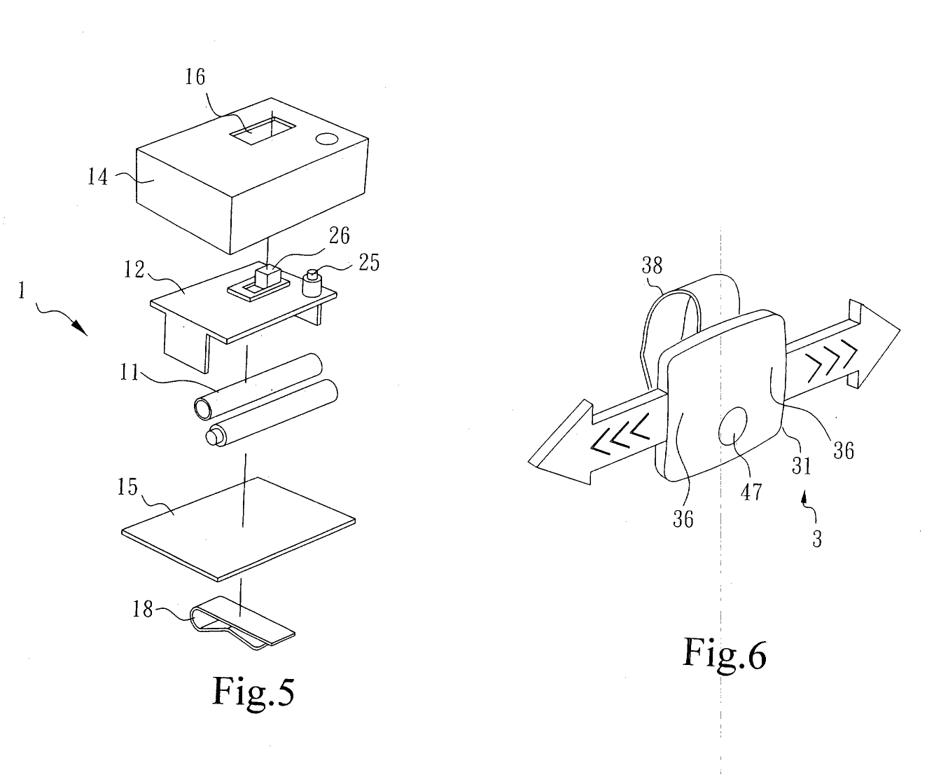

The signal, transmitter 1 is installed in a vehicle. The vehicle can be a motor-driven vehicle 5 (motorcycle, motor-scooter, or the like, see FIG. 1) or a human-driven vehicle 6 (bicycle, kick scooter, tricycle, or the like). The signal transmitter 1 is comprised of power supply, for example, a battery 11, a control circuit board 12, and a casing 13 accommodating the battery 11 and the control circuit board 12. A illustrated FIG. 5, the casing 13 is comprised of a top shell 14 and a bottom cover plate 15. The top shell 14 has a window 16. The control circuit board 12 comprises a power circuit 21 a direction selection circuit 22, an encoder circuit, 23, a transmitting circuit 24 and a directional switch 26. The power circuit 21 comprises an on/off switch 24. The directional switch 26 is adapted to select direction. When the directional switch 26 is switched to the desired direction it triggers the direction selection circuit 22 to produce a signal output. The battery 11 can be, for example, a set of #3 or #4 battery cells. Other electronic battery cells may be used as a substitute. Further, the connector for the battery 11 may be connected in parallel to the battery of the motorcycle 5 in addition, the directional switch 51 of the motorcycle 5 may be used to substitute for the directional switch 26. The transmitting circuit 24 is adapted to transmit the signal wirelessly. The encoder circuit 23 encodes the selected direction signal, enabling the encoded signal to be transmitted to the signal receiver 3 through the transmitting circuit 24 by infrared or radio signals.

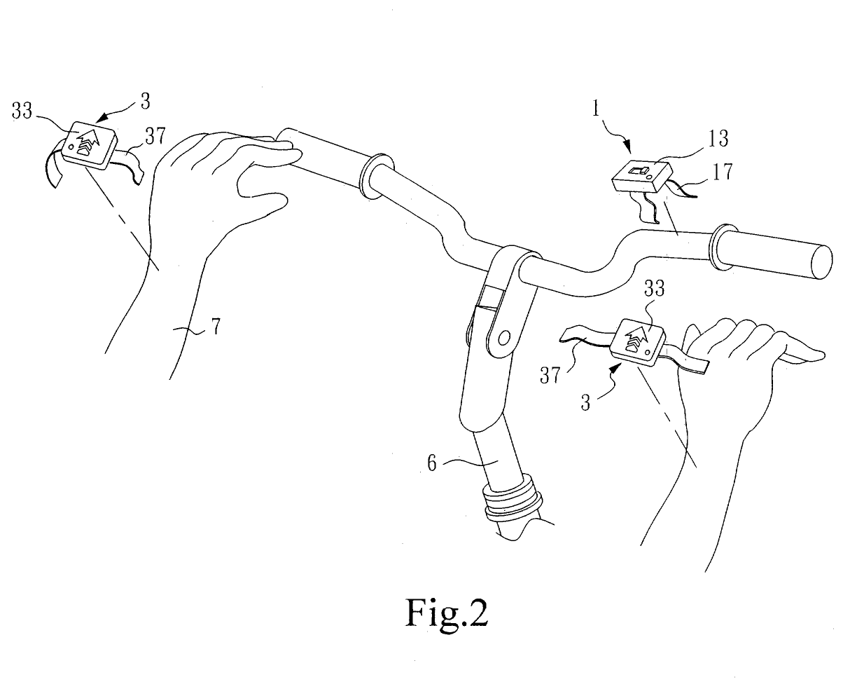

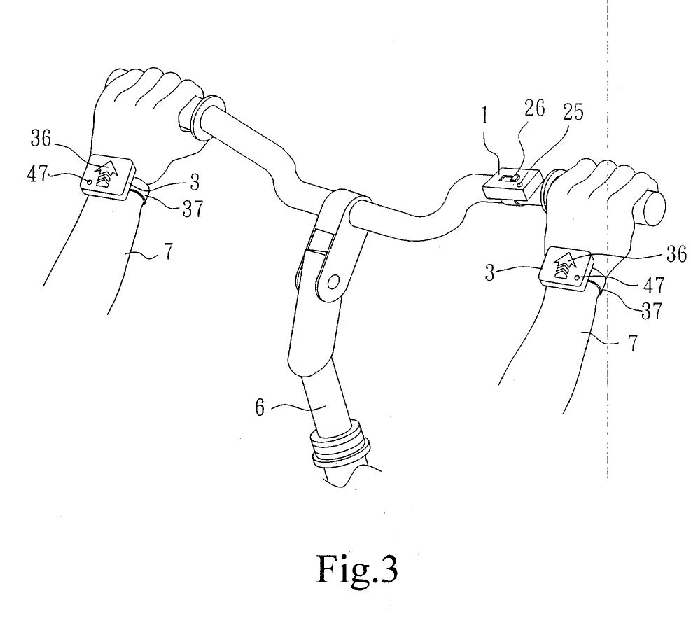

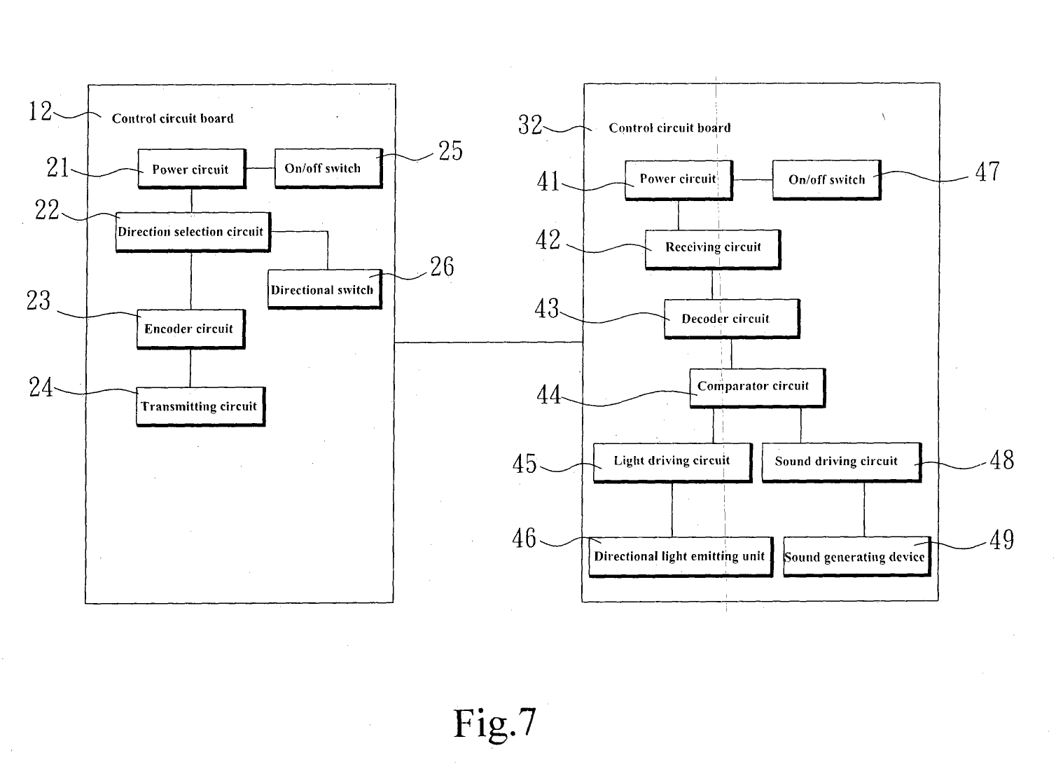

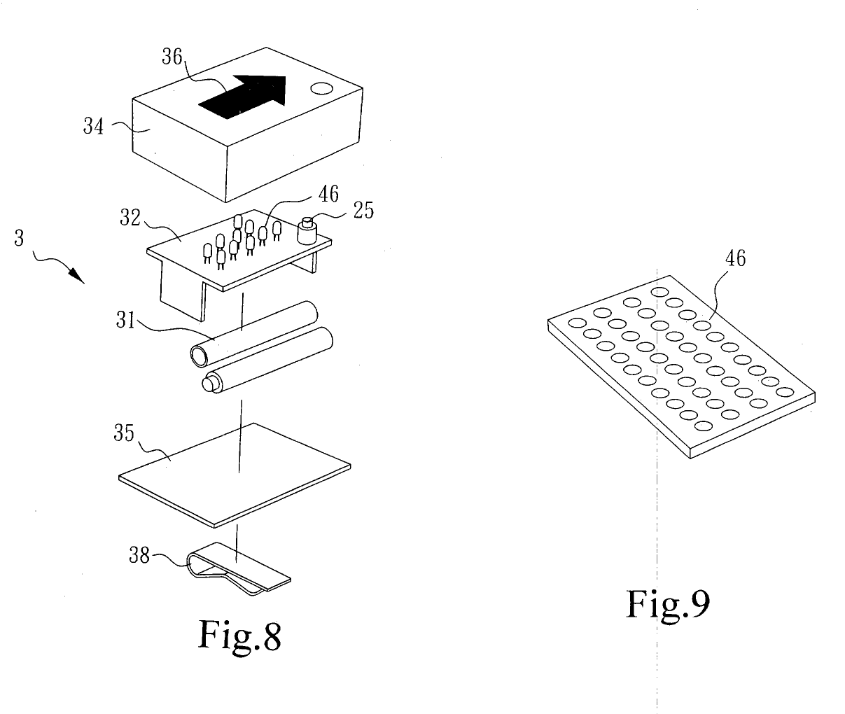

The signal receiver 3 carried on the user 7 is comprised of a power supply, for example a battery 31, a control circuit board 32, and a casing 33 accommodating the battery 31 and the control circuit board 32. As illustrated in FIG. 8, the casing 33 is comprised of a top shell 34 and a bottom cover plate 35. The top shell 34 has a direction index 36. The control circuit board 32 comprises a power circuit 41, a receiving circuit 42, a decoder circuit 43, a comparator circuit 44, a light driving circuit 45, and a directional light emitting unit 46 (see FIG. 7). The power circuit 41 comprises an on/off switch 47. The directional light emitting unit 46 is installed in the control circuit board 32, and controlled by the control circuit board 32 to emit light. The directional light emitting unit 46 may be variously embodied. For example, the directional light emitting unit 46 can be formed as a set of bulbs or light emitting diodes (LED), or a backlit LCD display panel. Alternately, a flexible light emitting polymer (LEP) device could be employed that both generates light and readily conforms to a curved or changing surface. FIG. 9 shows the directional light emitting unit 46 formed as a LED matrix. The control circuit board 32 further comprises a sound driving circuit 48 and a sound generating device, such as a horn, piezoelectric buzzer, or speaker 49. The light driving circuit 45 and the sound driving circuit 48 are connected in parallel to the comparator circuit 44, for enabling the directional signal device to produce light signal and sound signal at the same time. The battery set 31 can be a set of #3 or #4 battery cells. Other electronic battery cells may be used as a substitute. The receiving circuit 42 is adapted to wirelessly receive signals from the signal transmitter 1. The decoder circuit 43 is adapted to amplify and decode signals received from the receiving circuit 42, for enabling the decoded signals to be sent to the comparator circuit 43 for comparison. Compared signals are then sent to the directional light emitting unit 46, causing the directional light emitting unit 46 to flash accordingly, indicating the direction to go. In the embodiment shown in FIG. :1, there are two reversed direction indexes 36 (one for leftward indication and the other for rightward indication) on the casing of the signal receiver 3. In the embodiment shown in FIGS. 2 and 3, there are two receivers 3 used with one transmitter.

The casing 13 of the signal transmitter 1 is provided with a fastening belt 17 (see FIG. 13) or clip 18 (see FIG. 5) for mounting. The casing 33 of the signal receiver 3 is provided with a fastening belt 37 (see FIG. 13) or clip 38 (see FIG. 8) for mounting. The fastening belts 17 and 37 may be provided with hook and loop materials for fastening. By means of the belt 37 or clip 38, the signal receiver 3 can be conveniently fastened to the user's hand, head, body, bag, dress, or the like. Other fastening techniques may also be used, such as the use of Velcro to secure the receiver.

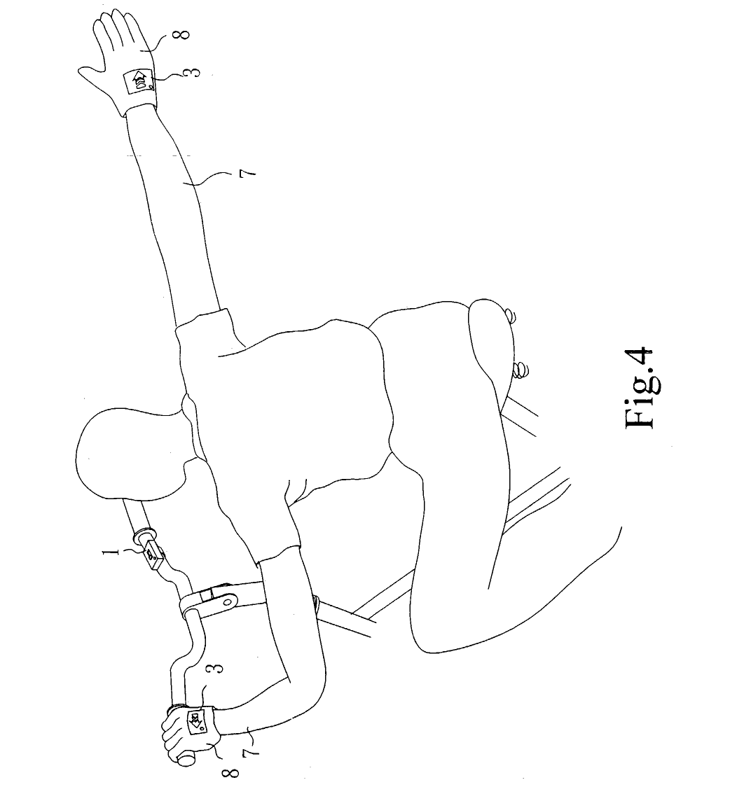

Alternately, the signal receiver 3 may be directly installed in a left-hand or right-hand glove. As illustrated in FIG. 4, two signal receivers 3 are respectively installed in the left-hand and right-hand gloves 8, which are worn by the user 7.

As indicated above, the invention uses wireless transmission technology to transmit signals from a signal transmitter to one or two signal receivers. By means of controlling the signal transmitter, a turn-left or turn-right directional signal is sent wirelessly to the signal receiver, causing the signal receiver to flash and to produce sound. Therefore, the signal receiver can be used as a third directional light.

A prototype of directional signal device has been constructed with the features of FIG. 19. The directional signal device functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

12 Control circuit board

21 Power circuit

22 Direction selection circuit

23 Encoder circuit

24 Transmitting circuit

25 On/off switch

26 Directional switch

32 Control circuit board

41 Power circuit

42 Receiving circuit

43 Decoder circuit

44 Comparator circuit

45 Light driving circuit

46 Directional light emitting unit

47 On/off switch

48 Sound driving circuit

49 Sound generating device

FIG. 7

What the invention claims is:

1. A directional signal device comprising:
a signal transmitter installed in a vehicle, said signal transmitter comprising a power supply, a control circuit board adapted to wirelessly transmit a directional signal, and a casing adapted to accommodate the power supply and the control circuit board of said signal transmitter, the control circuit board of said signal transmitter comprising a power circuit, a direction selection circuit, an encoder circuit, and a transmitting circuit; and
at least one signal receiver carried on the user and adapted receive directional signals from said signal transmitter, said receiver comprising a power supply, a control circuit board, and a casing adapted to accommodate the power supply and control circuit board of the respective signal receiver, the control circuit board of said signal receiver comprising a power circuit, a receiving circuit, a decoder circuit, a comparator circuit, a light driving circuit, and a directional light emitting unit;
wherein said signal transmitter is operated by the user to wirelessly transmit a directional signal to said one or more signal receivers; said one or more signal receivers each drives the respective directional light emitting unit to flash, indicating a direction to follow.

2. The directional signal device as claimed in claim 1, wherein the power supply of said signal transmitter is a battery.

3. The directional signal device as claimed in claim 1, wherein the power circuit of the control circuit board of said signal transmitter comp rises an on/off switch for power on/off control.

4. The directional signal device as claimed in claim 1, wherein the direction selection circuit comprises a direction selection switch for enabling the user to select the direction.

5. The directional signal device as claimed in claim 1 wherein the casing of said signal transmitter is provided with fastening means for fastening to the vehicle.

6. The directional signal device as claimed in claim 1, wherein the vehicle in which said signal transmitter is installed has a steering control handlebar.

7. The directional signal device a claimed in claim 1, wherein the power circuit of the control circuit board of each of the one or more signal receivers comprises ant on/off switch for power on/off control.

8. The directional signal device: as claimed in claim 1, wherein the control circuit board of each of the one or more signal receivers further comprises a sound driving circuit and a sound generating device for generating sound.

9. The directional signal device as claimed in claim 1 wherein the number of said at least one signal receiver is 2, and the casings of the two signal receivers are respectively installed in left-hand and right-hand gloves worn on the user's hands.

10. The directional signal device as claimed in claim 1, wherein the light emitting unit is selectively formed of light emitting diodes, lamp bulbs, a light emitting polymer display, or a backlit liquid crystal display panel.
